(19) United States
(12) Patent Application Publication
(10) Pub. No.: US 2013/0166807 A1
(43) Pub. Date: Jun. 27, 2013

(54) SAFELY EJECTING A CLIENT DEVICE USING A DEDICATED BUTTON

(71) Applicant: Continental Automotive Systems, Inc., Auburn Hills, MI (US)

(72) Inventor: Marcin Klimecki, Northbrook, IL (US)

(73) Assignee: CONTINENTAL AUTOMOTIVE SYSTEMS, INC., Auburn Hills, MI (US)

(21) Appl. No.: 13/622,479

(22) Filed: Sep. 19, 2012

Related U.S. Application Data
(60) Provisional application No. 61/579,009, filed on Dec. 22, 2011.

(51) Int. Cl. G06F 13/14

(52) U.S. Cl. 710/302

(57) ABSTRACT

Methods and systems for ejecting a device, including providing a host device, providing a client device, the client device being coupled to the host device, receiving a request to eject the client device, the request being initiated using a dedicated eject button, and in response to receiving the request, software-ejecting the client device.

### A. BACKGROUND

The invention relates generally to the field of safely ejecting one device from another, such as safely removing a client device from a host device.

### B. SUMMARY

In one respect, disclosed is a method for ejecting a device, the method comprising providing a host device, providing a client device, the client device being coupled to the host device, receiving a request to eject the client device, the request being initiated using a hardware eject button, and in response to receiving the request, software-ejecting the client device.

In another respect, disclosed is a system for ejecting a device, the system comprising one or more processors, one or more memory units coupled to the one or more processors, the system being configured to provide a host device, provide a client device, the client device being coupled to the host device, receive a request to eject the client device, the request being initiated using a hardware eject button, and in response to receiving the request, software-eject the client device.

In yet another respect, disclosed is a computer program product embodied in a computer-operable medium, the computer program product comprising logic instructions, the logic instructions being effective to provide a host device, provide a client device, the client device being coupled to the host device, receive a request to eject the client device, the request being initiated using a hardware eject button, and in response to receiving the request, software-eject the client device.

Numerous additional embodiments are also possible.

### C. BRIEF DESCRIPTION OF THE DRAWINGS

Other objects and advantages of the invention may become apparent upon reading the detailed description and upon reference to the accompanying drawings.

FIG. 1 is a block diagram illustrating a system for safely ejecting a client device from a host device by using a dedicated button on the client device, in accordance with some embodiments.

FIG. 2 is a block diagram illustrating a system for safely ejecting a client device from a host device by using a dedicated button on the host device, in accordance with some embodiments.

FIG. 3 is a circuit diagram illustrating an example circuit for safely ejecting a USB client device from a host device, in accordance with some embodiments.

FIG. 4 is a circuit diagram illustrating an alternative example circuit for safely ejecting a USB client device from a host device, in accordance with some embodiments.

FIG. 5 is a flow diagram illustrating a method for safely ejecting a client device from a host device, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

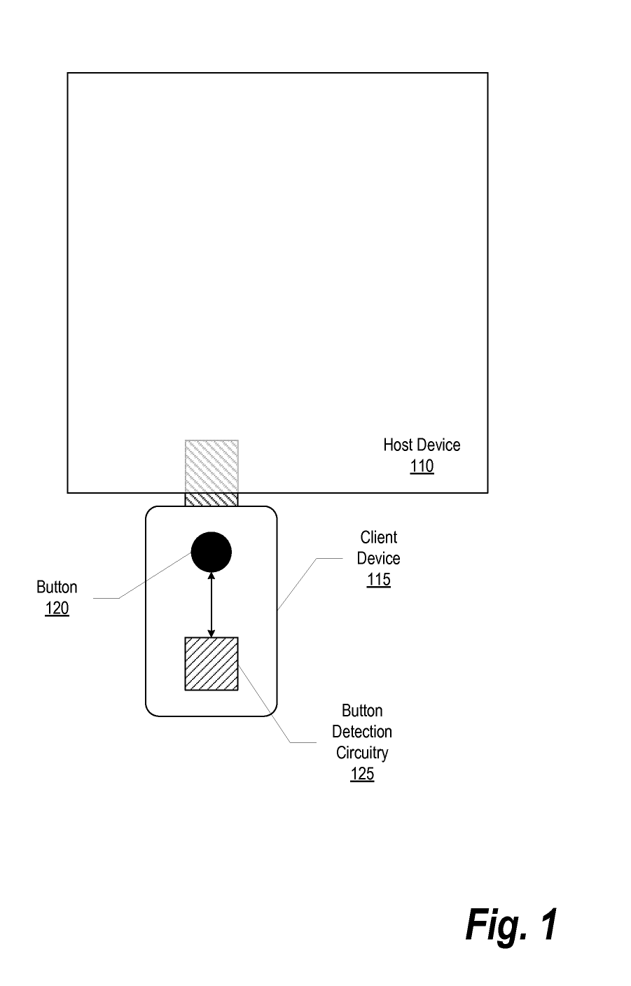

FIG. 1 is a block diagram illustrating a system for safely ejecting a client device from a host device by using a dedicated button on the client device, in accordance with some embodiments.

In some embodiments, client device 115 is configured to connect with host device 110. In some embodiments, the two devices may be connected for the purpose of transferring data, exchanging power (for charging, for example), etc. between the devices. In some embodiments, the two devices may be connected using the Universal Serial Bus (USB) protocol, where the host device 110 may be the USB host and client device 115 may be the USB client. In alternative embodiments, the devices may be connected using other protocols that require an ejection/disconnection procedure for safe removal/disconnection. It should also be noted that the protocols may also include wireless protocols.

In some embodiments, it may be important for the host and/or the client device to be notified prior to disconnecting the two devices. For example, the host and client devices may be in the process of transferring data, where disconnecting the two devices without notification may be lead to the corruption of data. Many protocols may provide a software-based solution (typically on the host) with which a user may notify the host and/or the client device that the user is about to disconnect the two devices. In response, the devices may safely discontinue any data transfers or other activities and prepare the two devices for safe disconnection/ejection. The preparation may involve safely cancelling any data transfers, unmounting any mounted drives, etc. After the preparation is complete, a notification may be issued to the user indicating that it is now safe for the user to proceed with disconnecting the two devices.

In many situations, however, it may not be very convenient to initiate the disconnection/ejection of the two devices via software. The software solution may require too many cumbersome steps, for example. Or it may be difficult to navigate the software, as may be the case, for example, in a moving automobile.

In some embodiments, eject button 120 is configured to initiate the disconnection process between client device 115 and host device 110. In some embodiments, eject button 120 may be dedicated to the ejection process for a device connected to specific socket. A user may, for example, press button 120 in order to initiate the disconnection process. Button detection circuitry 125 may be configured to detect an activation of button 120 and to then communicate the activation of the button to the appropriate software responsible for the safe disconnection of the two devices. The appropriate software may then proceed with the preparation of the two devices for disconnection. In some embodiments, after the successful implementation of the safe ejection/disconnection procedures, a user may be notified that it is now safe to physically disconnect the client device from the host device.

It should be noted that, in some embodiments, eject button 120 may be implemented as a hardware button. In alternative embodiments, button 120 may be implemented as a capacitive touch button, as an on-touch screen button, etc.

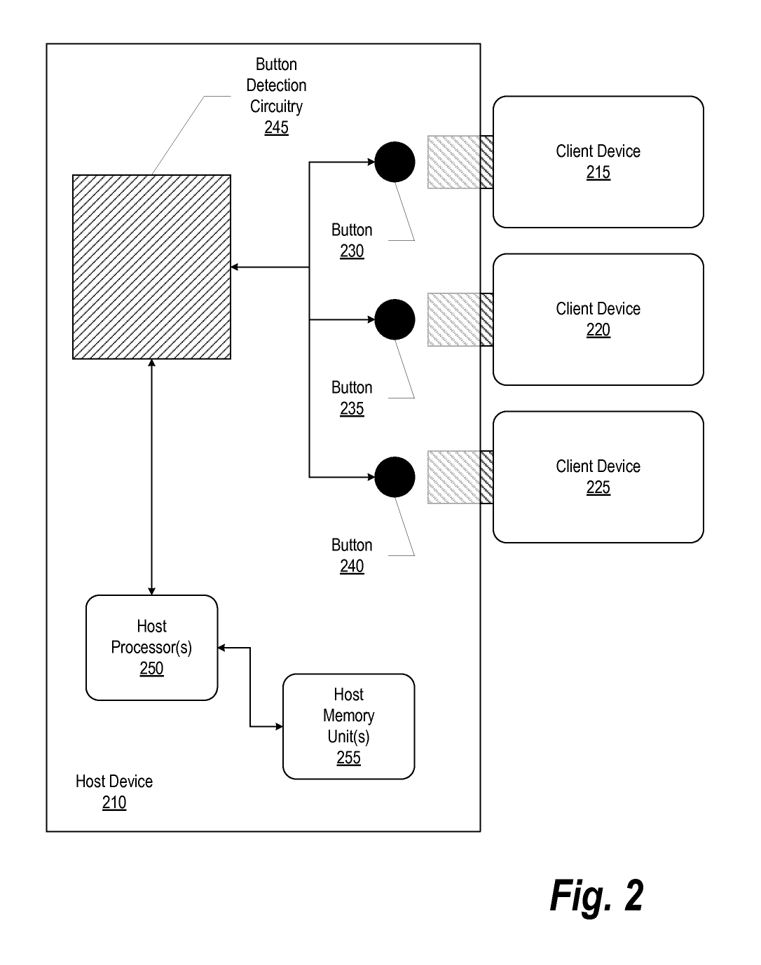

FIG. 2 is a block diagram illustrating a system for safely ejecting a client device from a host device by using a dedicated button on the host device, in accordance with some embodiments.

In some embodiments, client devices 215, 220, & 225 are configured to connect with host device 210. In some embodiments, the client devices may be connected to the host device for the purpose of transferring data, exchanging power (for charging one device from the other, for example), etc. In some embodiments, the devices may be connected using the Universal Serial Bus (USB) protocol. In alternative embodiments, a wireless protocol may also be used to connect the two devices.

In some embodiments, host device 210 may comprise eject buttons, such as eject buttons 230, 235, & 240. Each of the eject buttons 230, 235, & 240 may have corresponding sockets, each of which is configured to accept/connect to a client device, such as client devices 215, 220, & 225 as shown in the Figure.

In some embodiments, eject buttons 230, 235, & 240 may be configured to initiate the disconnection/ejection process between a corresponding one of client devices 215, 220, & 225 and host device 210. Button detection circuitry 245 may be configured to detect an activation of one of eject buttons 230, 235, & 240 and to then communicate the activation of the button to the appropriate software responsible for the safe disconnection/ejection of a corresponding one of client devices 215, 220, & 225. In some embodiments, after the successful implementation of the safe ejection/disconnection procedures, a user may be notified that it is now safe to physically disconnect the corresponding client device from host 210.

Button detection circuitry 245 is configured to connect one or more host processors 250, which are coupled to one or more host memory units 255. In some embodiments, host processors 250 may be responsible for executing the software responsible for the safe disconnection/ejection of client devices.

It should be noted that, in some embodiments, buttons 230, 235, & 240 may be implemented as hardware buttons. In alternative embodiments, buttons 230, 235, & 240 may be implemented as capacitive touch buttons, as on-touch screen buttons, etc.

It should also be noted that, in addition to the connection between the devices being a physical, wired connection, the connection may also be implemented using one or more wireless protocols.

In some embodiment, a single eject button may be used. In such embodiments, the user may indicate which client device is to be ejected using a single-click to indicate the first one, a double-click to indicate the second one, a triple-click to indicate the third one, etc. Alternative implementations may also be used.

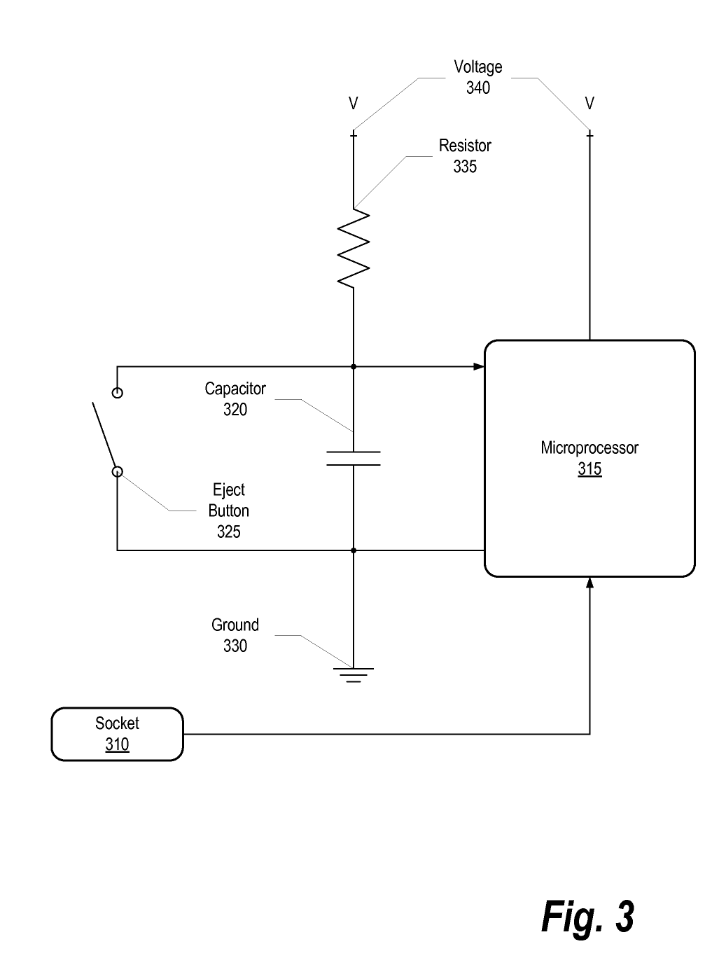

FIG. 3 is a circuit diagram illustrating an example circuit for safely ejecting a USB client device from a host device, in accordance with some embodiments.

In some embodiments, eject button 325 may be configured to initiate the safe disconnection of a client device and a host device. In some embodiments, eject button 325 may be mounted substantially close to socket 310, such that a user may easily locate eject button 325. For example, in embodiments where the eject button is implemented in an automobile, eject button 325 may be mounted such that the driver, for example, may easily access the button without getting distracted from driving the car. Socket 310 may be configured to receive and host a client device that may require safe removal before the physical disconnection of the device.

In some embodiments, the circuit may be given voltage 340 (relative to ground 330), which may be provided by the host device. Resistor 335 may also be provided in order to regulate/limit the voltage/current provided to eject button 325. And to the rest of the circuit

In some embodiments, eject button 325 may be connected to a “passive debounce circuit”, such as capacitor 320, in order to eliminate erroneous button presses of eject button 325. From the debounce circuit, the conditioned signal from eject button 325 may be then provided to microprocessor 315.

In embodiments where multiple eject buttons are used, each eject button may require its own microprocessor. In alternative embodiments, eject buttons may share a single microprocessor, configured to determine the identity of each eject button and each corresponding client device.

In some embodiments, software executing on the microprocessor may periodically examine whether eject button 325 is pressed. In alternative embodiments, an interrupt mechanism may be implemented to detect whether the eject button signal state has changed.

In some embodiments, once an eject button press is detected by the microprocessor, a software function may be invoked in order to decode the button press to a client device ID. The software function may then invoke an existing “safe removal process” and pass the client device ID to the safe removal process in order for the proper client device to safely removed by the process.

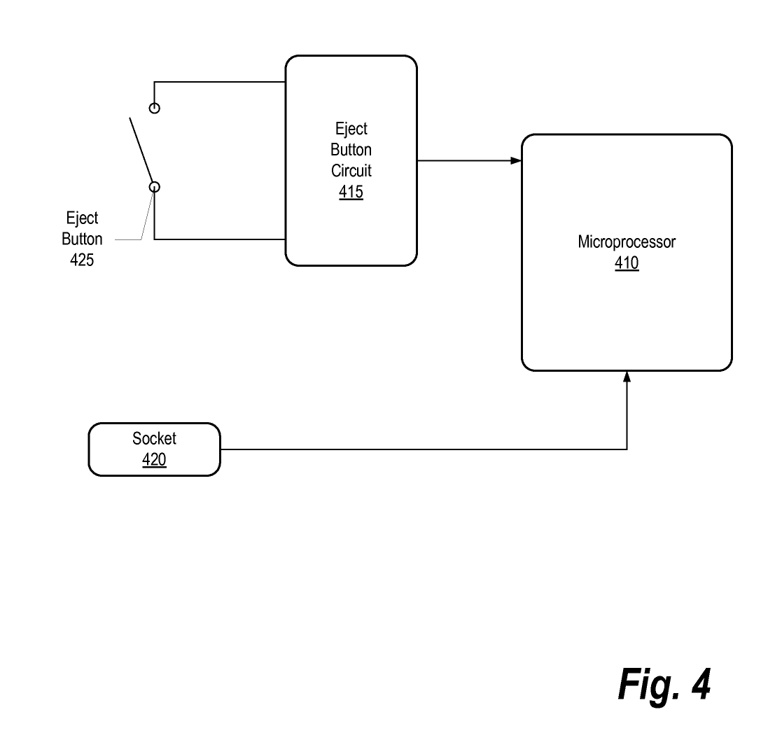

FIG. 4 is a circuit diagram illustrating an alternative example circuit for safely ejecting a USB client device from a host device, in accordance with some embodiments.

In some embodiments, eject button 425 and associated circuitry may be a separate client device requiring a software driver on the host device to enable the operation of the eject button. In some embodiments, the eject button(s) circuitry may be internal to the host device, and each eject button may have its own unique ID.

In some embodiments, the software function running under the OS, such as Windows, for example, may periodically examine whether eject button 425 is pressed. When the software detects that the eject button has been pressed, the software may record the ID associated with the eject button and then call an existing “safe removal process” and passes the detected ID associated with the eject button to the process. The safe removal process may then prepare the corresponding client device so that it may be safely removed. A notification may be then issued to the user after the save removal process is complete to inform the user that it is now safe for the user to physically remove the client device from the host device.

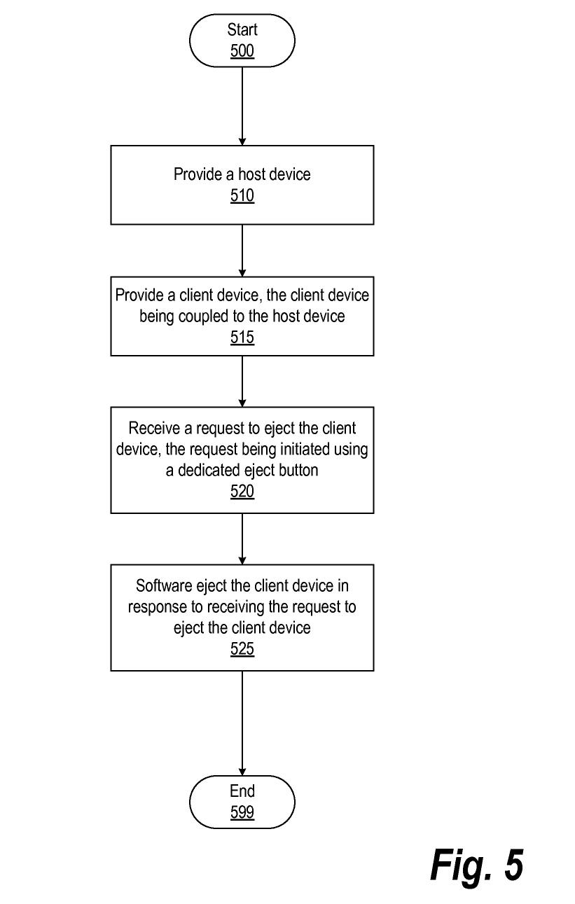

FIG. 5 is a flow diagram illustrating a method for safely ejecting a client device from a host device, in accordance with some embodiments.

In some embodiments, the method illustrated in this figure may be performed by one or more of the systems illustrated in FIG. 1-4.

Processing begins at 500 whereupon, at block 510, a host device is provided.

At block 515, a client device is provided, the client device being coupled to the host device.

At block 520, a request is received to eject the client device, the request being initiated using a dedicated button.

At block 525, the software device is software-ejected in response to receiving the request to eject the client device.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for ejecting a device, the method comprising:
providing a host device;
providing a client device, the client device being coupled to the host device;
receiving a request to eject the client device, the request being initiated using a dedicated eject button; and
in response to receiving the request, software-ejecting the client device.

2. The method of claim 1, where the hardware eject button is located on the client device.

3. The method of claim 1, where the hardware eject button is located on the host device.

4. The method of claim 1, where the host device and the client device communicate using the Universal Serial Bus protocol.

5. The method of claim 1, where software-ejecting the client device further comprises initiating a pre-configured software ejection procedure.

6. The method of claim 5, further comprising determining an ID corresponding to the client device.

7. A system for ejecting a device, the system comprising:
one or more processors;
one or more memory units coupled to the one or more processors;
the system being configured to:
provide a host device;
provide a client device, the client device being coupled to the host device;
receive a request to eject the client device, the request being initiated using a dedicated eject button; and
in response to receiving the request, software-eject the client device.

8. The system of claim 7, where the hardware eject button is located on the client device.

9. The system of claim 7, where the hardware eject button is located on the host device.

10. The system of claim 7, where the host device and the client device communicate using the Universal Serial Bus protocol.

11. The system of claim 7, where software-ejecting the client device further comprises initiating a pre-configured software ejection procedure.

12. The system of claim 11, where the system is further configured to determine an ID corresponding to the client device.

13. A computer program product embodied in a computer-operable medium, the computer program product comprising logic instructions, the logic instructions being effective to:
provide a host device;
provide a client device, the client device being coupled to the host device;
receive a request to eject the client device, the request being initiated using a dedicated eject button; and
in response to receiving the request, software-eject the client device.

14. The product of claim 13, where the hardware eject button is located on the client device.

15. The product of claim 13, where the hardware eject button is located on the host device.

16. The product of claim 13, where the host device and the client device communicate using the Universal Serial Bus protocol.

17. The product of claim 13, where software-ejecting the client device further comprises initiating a pre-configured software ejection procedure.

18. The product of claim 17, where the software code is further effective to an ID corresponding to the client device.
